(19) United States
(12) Patent Application Publication
(10) Pub. No.: US 2004/0026986 A1
(43) Pub. Date: Feb. 12, 2004

(54) Wheel, rim, rim eyelet and spoke nipple particularly for a bicycle

(75) Inventor: Gerrit Jager, Pery (CH)

Correspondence Address: GREER, BURNS & CRAIN, 300 S WACKER DR, 25TH FLOOR, CHICAGO, IL, 60606, US

(73) Assignee: DT Swiss AG Corporation

(21) Appl. No.: 10/396,259

(22) Filed: Mar. 25, 2003

(30) Foreign Application Priority Data
Mar. 26, 2002 (DE) 102 13 521.5

(51) Int. Cl. B60B 1/02

(52) U.S. Cl. 301/58

(57) ABSTRACT

A wheel, a rim, a rim eyelet and a spoke nipple, particularly for a bicycle, wherein the rim eyelet has a throughbore to receive a spoke nipple. The spoke nipple includes a nipple body and a nipple thread to work in concert with a spoke. At least one contact layer made from a material which effects a reduction in friction at the area of contact is provided between the spoke and the rim eyelet of the wheel's rim.

### BACKGROUND

The present invention relates to a wheel, a rim and a rim eyelet which are particularly suited for use on bicycles.

Moreover, such wheels, rims and rim eyelets do not have to be limited solely to use on bicycles alone but, in fact, it is just as conceivable to make use of the invention on other diverse single and multi-wheeled vehicles such as, for example, (bicycle) trailers, baby carriages and strollers, and other such wheels. For purposes of simplification, however, the invention will be described in the following substantially with respect to its use on bicycles, wherein said description is not to be construed as restrictive of the scope of the application.

Wheels usually have a central hub and an outer rim for a tire. The hub is connected to the rim by means of a varying number of up to 50 spokes. Spoke nipples are typically used to affix spokes to a wheel's rim, whereby the spoke nipples are usually configured as substantially cylindrical bodies which may have a thickening, the so-called nipple head, at one end, but which—depending upon application—may also not.

Holes are generally provided in rims into which rim eyelets are set in order to provide reinforcement, for example at the point where rims made of aluminum alloy receive spoke nipples. Such rim eyelets are usually manufactured from steel and may have an additional chrome-plating or may be alodined in order to harden the rim eyelets and protect against rust and abrasion. The rim eyelets are securely attached to the rim.

Embodiments are likewise known from the prior art in which the spoke nipples are not disposed on the rim but rather on the hub.

It is important for a wheel's stability that the spokes are appropriately tensioned since a spoke which breaks during operation can conceivably diminish riding safety to a considerable extent. For this reason, the causes for such spoke breakings should be curtailed to the greatest extent possible.

Besides for extrinsic causes such as improper handling and use of force, material fatigue in a spoke is one of the most frequent causes behind spokes breaking, whereby material fatigue fractures will develop once fatigue strength is exceeded.

Since spokes can typically only absorb tensile loads, the initial amount of tensioning to a spoke must be selected as high enough so that a sufficiently high residual stress (initial tension less compressive stress) will remain when strong forces are being exerted. On the other hand, the maximum tension to a tension spoke (initial tension plus tensile stress) must remain within the spoke's range of elasticity.

When a bicycle's wheel is rolling, the operational load alternately subjects a spoke to compressive and then tensile forces whereby given a load of, for example, 900 N (corresponds to roughly 90 kg load) and 32 spokes, said force being distributed, for example, over about three tension spokes and three compression spokes, a tension spoke basically receives about 300 N pull in addition to its initial tension and a compression spoke is slackened by about 300 N from the initial tension.

The spokes of a wheel when in rolling motion are therefore subject to a load of surging tensile stress, the amplitude of which in the chosen example amounts to 300 N.

Fatigue fracturing of spokes frequently occurs in the region of the thread. If, however, the initial tension is appropriately dimensioned, the tensioned shaft of the spoke absorbs the alternating loads within the range of elasticity with lasting fatigue strength, by means of which the thread is relieved of stress and fatigue fractures are by and large prevented. Adequate pre-tensioning will therefore counteract material fatigue and the breaking of spokes.

High-quality materials are employed for bicycle wheels in the recreational, semi-professional and professional realms, and light and rigid materials are used. In these types of wheels, the spokes are subjected to a high amount of tension during fitting so as to gain high tensile strength and to reduce the chances of any of the spokes loosening during operation. Although servicing may then in fact become necessary in these types of high-quality wheels even after just a short period of operation.

Therefore, it is the task of the present invention to provide a wheel, a rim and a rim eyelet, particularly for bicycles and the like, which results in more reliable operation and allows for a better fitting.

### SUMMARY

This task is solved in accordance with the present invention by the object of claims 1, 9 and 15.

Preferred embodiments of the invention constitute the subject matter of the subclaims.

The present invention provides a wheel having a hub, a rim, a plurality of spokes and a plurality of spoke nipples. The number of spokes and spoke nipples may hereby preferably be in the range of up to about 50, although may also be more.

Furthermore, at least one contact layer is provided at least one area of contact between rim, hub and spoke nipple which is made from a material which causes or effects a reduction in friction and/or a reduction in frictional torque for the spoke nipple, the rim eyelet respectively.

What is to be understood by contact layer in terms of the present application is that contact layer on the rim eyelet which comes into contact with the spoke nipple. Such contact layer at the spoke eyelet is a rim eyelet contact layer, and if at the spoke nipple, it is a spoke nipple contact layer.

The rim eyelet according to the present invention comprises a throughbore which is adapted to at least partially receive at least one spoke and at least one spoke nipple. The inventive rim eyelet is intended to be securely attached to the rim.

Furthermore, the rim eyelet comprises a rim mounting area and at least one contact layer at least one point of contact, whereby said contact layer is made from a material which causes or effects a reduction in frictional torque between spoke nipple and rim eyelet.

The inventive rim is particularly intended for use on a bicycle and has a rim profile which comprises at least one inventive rim eyelet disposed with a contact layer made from a material that induces a reduction in frictional torque from the boundary surface of the rim eyelet to the spoke nipple.

The inventive rim eyelet is intended to cooperate with a spoke nipple. Said spoke nipple comprises a nipple body and preferably a nipple head. The spoke nipple furthermore comprises a nipple thread to work in concert with a spoke.

At the periphery of the nipple body at least one contact layer is provided which is made from a material which, upon tensioning of the spoke nipple, effects a reduction in spoke nipple frictional torque compared to the frictional torque of a conventional spoke nipple.

The inventive object has numerous advantages.

The wheel according to the present invention allows a better adjusting to the desired or sought range of spoke tension since the reduced friction effect to the torque applied during fitting from the contact layer between the rim eyelet and the spoke nipple allows for a better correlating to the effective spoke nipple torque during fitting.

A greater reproducibility is also enabled when assembling the wheels in that the desired spoke tension can be set more exactingly, which results in increased operational safety.

In wheels known from the prior art, the area of contact between spoke nipple and rim eyelet is usually not tempered. The coefficient of friction between spoke nipple and rim eyelet is thus high, so that a not insignificant portion of the torque as applied goes to overcoming the frictional torque.

A further disadvantage to high frictional torque is that material abrasion ensues due to the friction occurring at the spoke nipple or the rim eyelet. This can result in a decrease in volume of up to two-thirds when spoking or re-spoking a wheel. This, in turn, results in considerably reduced shear strength and, hence, the stability of the wheel.

It is also for this reason that a reduction in frictional torque between rim eyelet and spoke nipple is important for reducing wear to the rim eyelet and the spoke nipple.

In the case of aluminum rims, chafing of the rims is also possible due to the high abrasion, while when making use of an aluminum nipple and an aluminum rim, such conditions may arise during insertion of the spokes that even a fusing of the point of contact between spoke nipple and rim eyelet is possible. Even if such a bonding only occurs intermittently at localized points, it still increases the frictional torque between spoke nipple and rim eyelet to a considerable degree such that it affects the quality of the spoked wheel, at times to an exceedingly negative extent.

Oil is sometimes applied to the rim eyelet or to the nipple immediately prior to assembly of today's wheels to reduce torque between rim eyelet and spoke nipple. This type of solution is, however, only marginally satisfactory because the oil which has been deposited forms a thin film which has but a low load bearing capacity. Given the temperatures which occur during spoking, which can reach 60° C. and higher, the effectiveness of such a film is greatly reduced, particularly since the high temperatures which occur can cause the applied oil to begin to scorch and vaporize. Using oil also results in undesirable contaminating of the spoking machine.

In conventional wheels not equipped with the inventive rim eyelet it may occur that, although the rim eyelet is securely attached to the rim, the rim eyelet shifts relative to the rim during rotation of the wheel because the frictional torque between spoke nipple and rim eyelet is extremely high. Such shifting of the rim eyelet in relation to the rim may cause higher abrasion and in the long run- damage the rim.

This problem is solved in the inventive rim eyelet in that both during fitting and during operation the contact layer reduces the frictional torque to such an extent that shifting between rim eyelet and rim is reliably prevented because there is only a small frictional torque between the inventive rim eyelet and the spoke nipple.

The inventive additional contact layer reduces the frictional torque between nipple and rim eyelet, so that the torque applied is better correlated to the torque effectively serving for the spoke tension, thus yielding better adjustment of desired spoke tension.

The present invention enables, on the one hand, a selectively specific lubrication or reduction in friction at the area of contact, which is also effective at high pressures and, on the other hand, the reduced amount of friction yields decreased abrasion and thus an enhanced stability to the spoke nipples and the rim eyelets as well as to the wheel as a whole. This allows a much finer adjusting to be made to the individual spoke tensions as well as also the distribution of spoke tension over the individual spokes of a wheel, leading in turn to a wheel which, as a whole, can be better adjusted.

As a consequence, spoke tension is better adjusted with the wheel according to the present invention, thus also raising the level of operational safety. This also results in extending the intervals between servicing.

The contact layer made from a friction-reducing material is provided at the area of contact with the spoke nipple. This layer is provided at the rim eyelets.

It is also conceivable to provide for two or more contact layers, whereby one is provided on, for example, the spoke nipple and one on the rim eyelet. The individual contact layers may be made from the same or from different materials.

In a preferred embodiment of the inventive wheel, at least one contact layer is made of a material which has a lubricating effect. Particularly preferential is for the lubricating effect to first occur under high pressures, namely such pressures as arise, for example, between spoke nipple and rim and/or hub in the case of known wheels and rims. A lubricating effect is particularly advantageous since a particularly reliable and durable reduction in frictional torque is thereby attainable.

In another preferential embodiment of the invention, at least one contact layer consists of a substantially non-volatile material. This embodiment is particularly advantageous since the shelf life of an inventive rim eyelet or rim is substantially dependent upon whether the contact layer remains constant; i.e., non-volatile.

In conjunction hereto, applicant points out that applicant also herewith asserts claimed use of a procedure based on the application for the manufacture of an agent for reducing the frictional torque which comprises, for example, the following steps in the given or any other logical order:

a) fitting an eyelet into a rim

b) applying a contact layer to at least the area of the rim eyelet which comes into contact with a spoke nipple.

Another possible procedure is to first provide the rim eyelet with a contact layer comprising a lubricant or the like and then fit or mount the rim eyelet or spoke nipple to the rim.

In a preferred embodiment of the invention, the contact layer is made substantially from a material which is one of among a group of materials which includes organic and inorganic, metallic and non-metallic materials, as well as materials mixed with a binding agent such as graphite, wax, silicone, greases, oils and soaps, molybdenum, nickel or also synthetic materials, Polytetrafluorethylen, powder coatings and the like.

Synthetic materials such as Polytetrafluorethylen, commonly referred to by the brand name of “Teflon,” are extremely advantageous since such materials have a particularly low coefficient of friction.

The contact layer may also comprise a metal layer applied in a galvanic procedure. Such a layer may also be applied in a vapor deposition process (for example, “chemical vapor deposition” or “physical vapor deposition,” etc.).

Softer metals and the like are advantageous since same have a certain stability and are thus well-suited for storage, even when the contact layer is disposed on an external surface which might, for example, come into contact with other components (for example, quantities of rim eyelets conceivably stored together in one receptacle), while they are also capable of reducing frictional torque to a considerable degree.

It is also advantageous in this respect if the contact layer on a rim is disposed at the rim eyelet since the contact layer is then situated in protected fashion within the (inner) region of the rim.

The inventive rim eyelet preferably consists of, apart from the contact layer, a substantially rigid material which may be, for example, one from among a group of materials which includes steel, stainless steel, etc. Depending upon application, the rim eyelet may also be made from brass or the like.

In a preferred embodiment of the inventive rim eyelet, the contact layer substantially fully encases the rim eyelet, as is able to be attained with, for example, galvanic or vapor deposition procedures.

A spoke nipple for use with an inventive rim eyelet is preferably made from metal and particularly preferably from a light metal or aluminum, etc., although the contact layer between the spoke nipple and an inventive rim eyelet is comprised of one of the above-cited materials.

Particularly in the case of a spoke nipple having a contact layer, it is preferred for the contact layer to be provided on an outer area of the nipple body; especially preferred is the providing of same solely on an outer region of the nipple body.

While the reducing of frictional torque between the nipple body and the rim or between the spoke nipple and the eyelet in the rim or the hub is desirably beneficial, a consistent reduction in frictional torque between the spoke nipple thread and the spoke thread is undesirable since a reduction of the frictional torque in the spoke thread can lead to a loosening of the spoke during operation. Depending upon application, such a contingency should be ruled out entirely.

This can be ensured when manufacturing the contact layer in a galvanic or vapor deposition process by, for example, not making the bore through the nipple or fabricating the nipple thread until after the contact layer has been applied during said process. It is however just as feasible to apply the contact layer at a later point in time and to draw upon suitable measures to ensure that the thread is free of agents which would induce (consistent) reduction of friction.

In a preferred embodiment of the inventive wheel the spoke nipples further comprise a quantity of adhesive provided preferably at an area on, for example, the nipple thread. Such a quantity of adhesive can, for example, serve two purposes; namely one of reducing the friction at the thread when screwing the spoke nipple onto a spoke due to the lubricating effect of the adhesive, so that the screwing operation will then be a smoother and more facilitated process, and secondly, the adhesive will act to provide an additional securing of the screwed fit between spoke nipple and spoke following its hardening.

For a more precise definition of this type of adhesive configuration and composition, reference is herewith made to the applicant's German patent application, published as DE 100 52 528 A1, which describes the configuring of a spoke nipple with a quantity of adhesive.

Such quantity of an adhesive causes the frictional torque between spoke nipple and spoke thread to be reduced for a short time but not permanently. Such permanent reduction is achieved with the contact layer at the inventive rim eyelet.

### BRIEF DESCRIPTION OF THE DRAWINGS

Further advantages and possibilities for application of the present invention will yield from the following embodiments described with reference to the figures, which show:

FIG. 1 an inventive wheel of a bicycle;

FIG. 2 an inventive rear wheel in section;

FIG. 3 an inventive front wheel in section;

FIG. 4 an inventive rim eyelet in section; and

FIG. 5 a spoke nipple of an inventive wheel.

### DETAILED DESCRIPTION

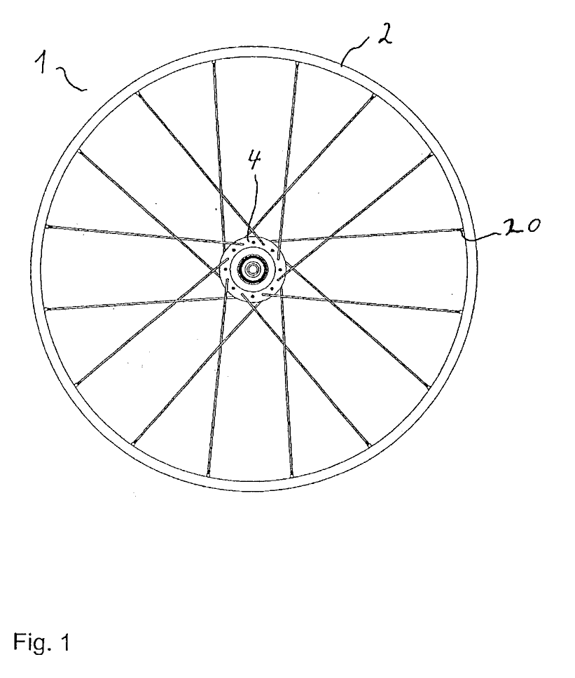

FIG. 1 depicts an inventive wheel 1 of a bicycle. Wheel 1 comprises a rim 2, spokes 3 with spoke nipples 20 and a central hub 4.

While the spoke heads of spokes 3 are provided on the hub flanges of hub 4, the spoke nipples are disposed at rim eyelets 10 of rim 2. The rim eyelets 10 are securely attached to rim 2. The nipple area of contact in inventive wheel 1 is disposed at the rim eyelets 10 of rim 2.

A further nipple contact layer may also be provided at the spoke nipples. Also, a first contact layer type may be provided at the rim eyelet and a second contact layer type at the spoke nipple wherein the first type consists of a first material and the second type of a second material.

This enables a more precise adjusting of the spoke tension during fitting since the frictional torque between spoke nipple 20 and rim eyelet 10 can conceivably be reduced considerably. The torque applied by a spoking machine or manually is thus correlated considerably better to the tensile stress prevailing in the spoke.

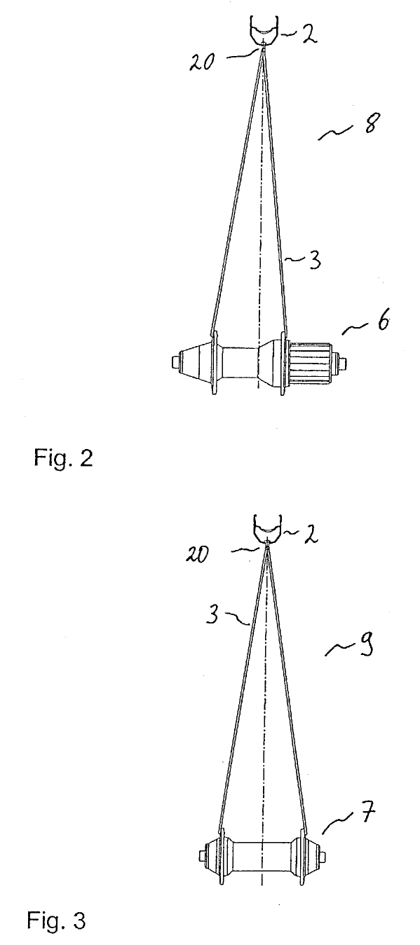

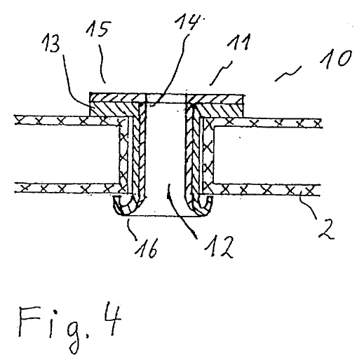

The inventive rim eyelet and the inventive rim 2 respectively, may be used on an inventive rear wheel 8 as depicted in FIG. 2, which has a freewheel 6 for receiving a sprocket having a plurality of gearwheels, just as feasibly as the inventive wheel being configured as a front wheel 9 having a front wheel hub 7, as depicted in FIG. 3. FIG. 4 shows an inventive rim eyelet 10 which is set into rim 2. The connection is secure.

Rim eyelet 10 has a throughbore 12 through which a spoke is introduced or guided through by its thread end from the hub outwardly. Rim eyelet 10 positions on rim 2 via rim mounting area 13. In the given embodiment, rim eyelet 10 is held firmly in rim 2, for example is driven into rim 2.

Contact layer 11 in the embodiment according to FIG. 4 is disposed within throughbore 12 and at the topside 15 of rim eyelet 10.

The nipple area of contact 14 is disposed at an upper region of the rim opening which abuts up against the nipple when fitted. In the embodiment according to FIG. 4, underside 16 of rim eyelet 10 is not provided with a contact layer.

It is, however, pointed out that the contact layer may also be provided anywhere upon the rim eyelet, on all (e.g. accessible) surfaces. It may likewise only be provided over portions of the mentioned surfaces.

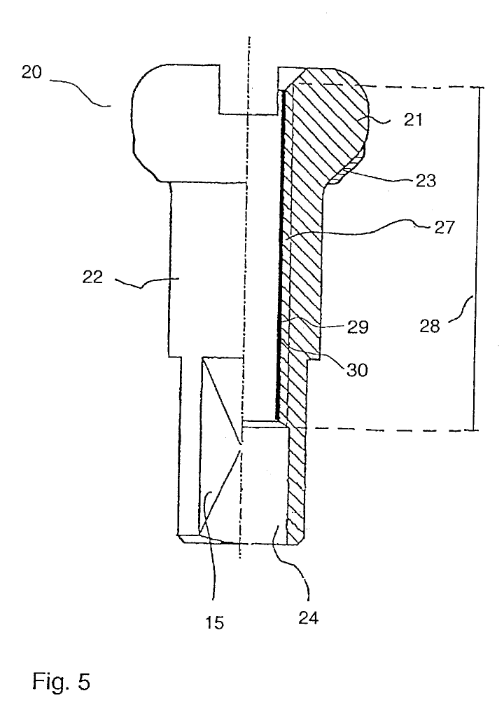

The spoke nipple 20 depicted in FIG. 5 for use in an inventive wheel comprises a nipple head 21 with contact layer 23 being provided at its outer side in the region of the head thickening. Contact layer 23 may also extend over, or also only extend partly over, cylindrical area 22 of the spoke nipple.

Thread 27, which works in concert with the thread on the spoke, extends over a length 28 in a central bore 24 of the spoke nipple.

Spoke nipple 20 has a square bar configuration with side faces 15 at its lower region so as to enabling grasping with a tool during fitting.

In a preferred embodiment of the invention, the contact layer 11, 23 is made substantially from a material which is one of among a group of materials which includes organic and inorganic, metallic and non-metallic materials, as well as materials mixed with a binding agent such as graphite, wax, silicone, greases, oils and soaps, molybdenum, nickel or also synthetic materials, Polytetrafluorethylen, powder coatings and the like.

Synthetic materials such as Polytetrafluorethylen, commonly referred to by the brand name of “Teflon,” are extremely advantageous since such materials have a particularly low coefficient of friction.

The contact layer 11 may also comprise a metal layer applied in a galvanic procedure. Such a layer may also be applied in a vapor deposition process (for example, “chemical vapor deposition” or “physical vapor deposition,” etc.).

Softer metals and the like are advantageous since same have a certain stability and are thus well-suited for storage, even when the contact layer is disposed on an external surface which might, for example, come into contact with other components (for example, quantities of rim eyelets conceivably stored together in one receptacle), while they are also capable of reducing frictional torque to a considerable degree.

It is also advantageous in this respect if the contact layer 11 on a rim is disposed at the rim eyelet since the contact layer is then situated in protected fashion within the (inner) region of the rim.

The inventive rim eyelet preferably consists of, apart from the contact layer 11, a substantially rigid material which may be, for example, one from among a group of materials which includes steel, stainless steel, etc. Depending upon application, the rim eyelet may also be made from brass or the like.

In a preferred embodiment of the inventive rim eyelet, the contact layer 11, substantially fully encase the rim eyelet, as is able to be attained with, for example, galvanic or vapor deposition procedures.

Referring again to FIG. 5, a quantity of adhesive 29 is arranged in the area of central bore in the interior of the spoke nipple. In the present embodiment, quantity of adhesive 29 is disposed over a portion of the thread length 28 of spoke nipple 20.

The quantity of adhesive is preferably an adhesive which is microencapsulated as a dual or multi-component adhesive capable of being stored. Screwing in a spoke at least partly destroys the microencapsulation and activates said quantity of adhesive 29.

This leads, on the one hand, to a lubricating of thread 27 of inventive spoke nipple 20 so that there will be less friction during the screwing process and, on the other hand, quantity of adhesive 29 induces a tighter bond between spoke and nipple following hardening.

It is also possible to make use of an adhesive having a blend of components or one comprised of only one component and a separate protective coating 30.

With regard to the type of adhesive and its further details as well as configuration, reference is again made to the above-noted DE 100 02 528 A1, the contents of which and particularly the contents of the description in columns 1-15 as well as FIGS. 1-3 are hereby also expressly incorporated into the contents of the present application.

Should a spoke be introduced into a spoke nipple 20 in accordance with FIG. 5, the thread of the spoke then activates the quantity of adhesive 29 disposed at nipple thread 27.

Such spoke nipple may also be used together with an inventive rim eyelet. In the case of a wheel according to the present invention, both components may be employed individually or concurrently.

What is claimed is:

1. A wheel, particularly for a bicycle, comprising:
a hub;
a rim with a plurality of rim eyelets;
a plurality of spokes;
a plurality of spoke nipples;
wherein at least one contact layer made from a material which causes a reduction in friction is provided at the plurality of rim eyelets for reducing the friction between rim eyelets and spoke nipples.

2. The wheel according to claim 1, wherein at least one of said at least one contact layer is provided which is made from a material having a lubricating effect.

3. The wheel according to claim 1, wherein at least one of said at least one contact layer consists of a substantially non-volatile material.

4. The wheel according to claim 1, wherein at least one of said at least one contact layer consists substantially of a material taken from among a group of materials which includes organic and inorganic, metallic and non-metallic materials, material mixed with a binding agent such as graphite as well as wax, silicone, greases, oils and soaps, molybdenum, nickel or also synthetic materials, polytetrafluoroethylene, and powder coatings.

5. The wheel according to claim 1, wherein at least one of said at least one contact layer is applied via a galvanic procedure.

6. The wheel according to claim 1, wherein at least one of said at least one contact layer is applied via a vapor deposition process.

7. The wheel according to claim 1, wherein at least one spoke nipple comprises at least one of said at least one contact layer at an outer region of said spoke nipple.

8. The wheel according to claim 1, wherein a quantity of adhesive is disposed at a nipple thread of the spoke nipple.

9. A rim, particularly for a bicycle, comprising:
a rim profile;
at least one rim eyelet which is adapted to at least partially receive a spoke and a spoke nipple;
at least one contact layer disposed on the rim eyelet for the reduction of friction.

10. The rim according to claim 9, wherein at least one of said at least one contact layer is made from a material having a lubricating effect.

11. The rim according to claim 9, wherein at least one of said at least one contact layer consists of a substantially non-volatile material.

12. The rim according to claim 9, wherein at least one of said at least one contact layer consists substantially of a material taken from among a group of materials which includes organic and inorganic, metallic and non-metallic materials, material mixed with a binding agent such as graphite as well as wax, silicone, greases, oils and soaps, molybdenum, nickel or also synthetic materials, Polytetrafluorethylen, and powder coatings.

13. The rim according to claim 9, wherein at least one of said at least one contact layer is applied via a galvanic procedure.

14. The rim according to claim 9, wherein at least one of said at least one contact layer is applied via a vapor deposition process.

15. A rim eyelet, particularly for a bicycle, comprising:
a throughbore which is adapted to at least partially receive a spoke and a spoke nipple;
at least one rim mounting area; and
at least one contact layer which is provided for the reduction of friction.

16. The rim eyelet in accordance with claim 15, wherein at least one of said at least one contact layer consists substantially of a material taken from among a group of materials which includes organic and inorganic, metallic and non-metallic materials, material mixed with a binding agent such as graphite as well as wax, silicone, greases, oils and soaps, molybdenum, nickel or also synthetic materials, Polytetrafluorethylen, and powder coatings.

17. The rim eyelet according to claim 15 which, apart from said contact layer, consists substantially of a material taken from among a group of materials which includes steel and stainless steel.

18. The rim eyelet according to claim 15, wherein said contact layer substantially fully encases said rim eyelet.

19. The rim eyelet according to claim 15, wherein at least one of said at least one contact layer is provided which is made from a material having a lubricating effect.

20. The rim eyelet according to claim 15, wherein at least one of said at least one contact layer consists of a substantially non-volatile material.

21. A spoke nipple, particularly for a bicycle comprising:
a nipple body;
a nipple thread on said body for accommodating a spoke; and
at least one contact layer is provided on said nipple for the reduction of friction.

22. The spoke nipple according to claim 21, wherein at least one of said at least one contact layer consists substantially of a material taken from among a group of materials which includes organic and inorganic, metallic and non-metallic materials, material mixed with a binding agent such as graphite as well as wax, silicone, greases, oils and soaps, molybdenum, nickel or also synthetic materials, Polytetrafluorethylen, and powder coatings.

23. The spoke nipple according to claim 21, particularly for a bicycle, wherein a quantity of adhesive is disposed at the nipple thread.

24. The spoke nipple according to according to claim 21, wherein said contact layer is provided on a thickened head area of said body.
